(19) United States
(12) Patent Application Publication
(10) Pub. No.: US 2002/0147585 A1
(43) Pub. Date: Oct. 10, 2002

(54) Voice activity detection

(76) Inventors: Steven P. Poulsen, East Amherst, NY (US); Joseph S. Ott, Depew, NY (US)

Correspondence Address: Martin G. Linihan, Esq., Hodgson Russ LLP, Suite 2000, One M&T Plaza, Buffalo, NY, 14203-2391, US

(21) Appl. No.: 09/828,400

(22) Filed: Apr. 6, 2001

(51) Int. Cl. G10L 15/20; G10L 15/00

(52) U.S. Cl. 704/233

(57) ABSTRACT

A system and method for detecting a signal of interest, for example a voice signal, in a composite signal, for example a composite of voice and non-voice signals, is described.

### BACKGROUND

This invention relates to detecting the signal component of interest in a composite signal, and more particularly to detecting the voice signal component in a composite signal in a telephony network.

Voice activity detection plays an important role in a number of telephony applications. One example is the controller in a voice mail system (VMS). Another is in cell phones where it is desired to transmit power when the user speaks into the phone. A further example is in answering machines wherein it is desired to stop the recording mechanism when voice no longer is received. A problem with voice activity detection (VAD) algorithms heretofore available is that at times several syllables or words are required before voice is detected. The effect of this is that the telephony application will not show a connect state fast enough. Accordingly, it would be highly desirable to provide a voice activity detection algorithm having an improved detection rate and speed without degradation to false detection characteristics.

### BRIEF DESCRIPTION OF THE DRAWING FIGURES

FIG. 1 is a block diagram illustrating the system and method of one embodiment of the invention employed in a telephone network;

FIG. 2 is a block diagram illustrating the system and method of one embodiment of the invention;

FIG. 3 is a flow diagram further illustrating the FFT power processing component of the system and method of FIG. 2;

FIG. 4 is a schematic diagram illustrating the overlapping employed in the component of FIG. 3;

FIG. 5 is a graph illustrating the windowed FFT employed in the component of FIG. 3;

FIG. 6 is a graph illustrating an illustrative method of analyzing the power spectrum output of the component of FIG. 3;

FIG. 7 is a schematic block diagram further illustrating th frame validation component of the system and method of FIG. 2;

FIG. 8 is a schematic block diagram further illustrating the flywheel routine component of the system and method of FIG. 2;

FIG. 9 is a schematic block diagram further illustrating the near-end/far-end power comparison component of the system and method of FIG. 2;

### DETAILED DESCRIPTION

FIG. 1 illustrates an embodiment of the system and method of the invention utilized in a telephone network, in particular in a telephone emulation application. By telephone emulation is meant a hardware or software system or platform that performs telephone-like functions. In the arrangement of FIG. 1, an emulated telephone 10 is at one end which is designated the near end, and a voice network 12 is at the other end which is designated the far end. Near-end speech travels along a first path or channel 14 from emulated telephone 10 to the voice network 12. Far-end speech travels along a second path or channel 16 from voice network 12 to emulated telephone 10. The near-end speech can be echoed by the voice network so that the far-end speech also can contain an echo.

The voice activity detection system of the invention is designated 20 and receives inputs along paths 22 and 24 from channels 14 and 16. As will be explained in detail presently, it is desired that system 20 detect the far-end speech while reducing false detection due to the echo. The output of system 20 is connected by path 26 to a utilization device 28 in the network. For example, device 28 can be the controller in a voice mail system (VMS), although the scope of the embodiments are not limited in this respect.

More particularly, system 20 functions to detect a signal component of interest in a composite signal. One embodiment of the invention detects voice signals in a composite of voice and non-voice signals such as data signals, noise and echo, as well as to detect voice signals in a composite of voice and network tones. For example, system 20 can be software running on a digital signal processor (DSP), or system 20 can be logic in a programmable gate array. In addition, system 20 can be a program of instructions tangibly embodied in a program storage device which is readable by a machine for execution of the instructions by the machine. System 20 comprises a processing component 30 which accumulates a number of samples of the composite signal to provide a series of frames each containing the same number of signal samples and to transform each frame to provide transform products in the frame. By transform products is meant the power spectrum of the frame. In the voice activity system and method, component 30 performs a Fast Fourier Transform (FFT) on the signal as will be described in detail presently. Processing component 30 may receive its input in the form of the far end audio signals from path 24 in the arrangement of FIG. 1 and through a buffer 32, for example.

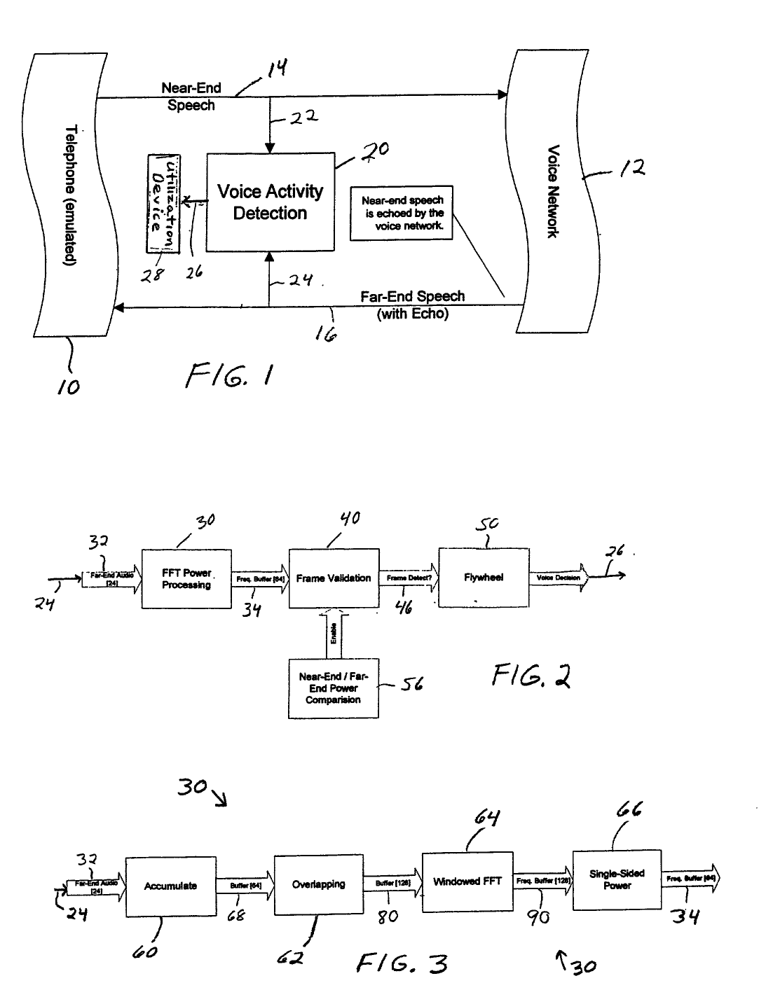

The output of processing component 30 passes through a buffer 34 to the input of a frame validation component 40 in the system 20 of FIG. 2. Frame validation component 40 analyzes each frame it receives to determine the number of transform products in the frame which have an amplitude above a computed threshold. Frame validation component 40 also compares that number to a validation range to determine if the frame contains the signal component of interest, i.e. a voice signal. The output of frame validation component 40 is an indication whether or not a signal component of interest was determined to be present in each frame which was analyzed. Frame validation component 40 will be shown and described in further detail presently.

The output of the frame validation component 40 is transmitted through path 46 to the input of a component 50, designated flywheel routine, which determines if the signal component of interest, e.g., a voice signal, is present in the composite signal based on the series of frames sequentially analyzed by frame validation component 40. Flywheel routine 50, which will be described in detail presently, counts the number of frames containing the signal component of interest, e.g., a voice signal, until a predetermined number of frames is obtained indicating that the system 20 is satisfied that the signal component of interest is present in the composite signal. The output of component 50 is a signal to that effect, which in the example of FIG. 1 is transmitted via path 26 to controller 28.

The system 20 shown in FIG. 2 also may include a component 56 which detects the presence of a predetermined characteristic in the composite signal and which enables or disables the operation of frame validation component 40 if that predetermined characteristic is present. Component 56 will be described in detail presently. For example, when the signal component of interest is voice and when echo signals are present in the composite signal, component 56 may perform a near end/far end power comparison. This, in turn, enables or disables the system 20 to detect far-end speech in a situation like that of FIG. 1 while ignoring the echo by examining the near-end speech power.

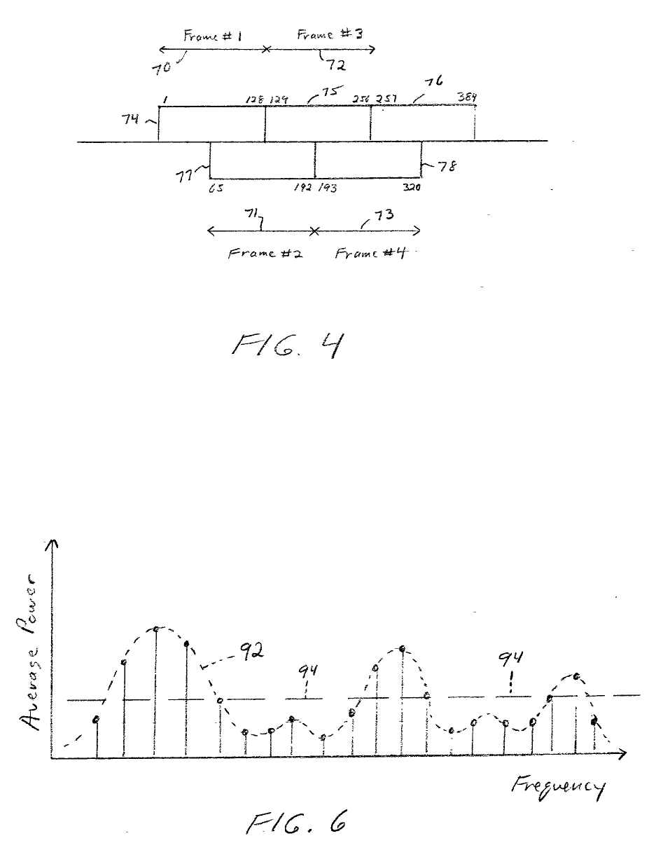

The operation of processing component 30 is illustrated further in FIG. 3. Briefly, signal samples are accumulated in stage 60, overlapping of samples is provided in stage 62, a windowed Fast Fourier Transform (FFT) is performed on the samples in stage 64 and in stage 66 a scaled spectral power of the samples is computed. In particular, the FFT is used to analyze the spectral density of a signal. In one embodiment of the present invention samples accumulate from 24 samples in buffer 32 through stage 60 to 64 samples in buffer 68.

The overlap method involved in stage 62 refers to which input samples are processed at what time. The FFT processes a fixed amount of data at a time. In one embodiment of the invention that amount may be 128 samples. By samples is meant measured values at selected times and in this embodiment at periodic times. Typically samples 1 through 128 would be processed by the FFT then samples 129 through 256 would be processed and so on. Since each sample is only processed once in the typical operation, the output of the FTT does not overlap. In the overlap method utilized in the present invention, some of the samples previously processed by the FFT are processed again. In the present case 50% of the previously processed samples are reused. In this case samples 1 though 128 would be processed by the FFT then samples 65 through 192 would be processed followed by samples 128 through 256. Each FFT used 64 samples from the last time and 64 new samples. The FFT output overlaps by 64 of the 128 samples or 50%. The overlapping of stage 62 is employed because syllables in voice signals were found to be typically one FFT frame in length. Without overlapping, the syllable may end up partially in each adjacent frame, and this would result in loss of voice information in the FFT of that signal sample. This is illustrated further in the diagram of FIG. 4 wherein arrows 70, 71, 72 and 73 indicate successive frames used as input to the FFT and the rectangles 74, 75, 76, 77 and 78 represent the groups of samples described hereinabove.

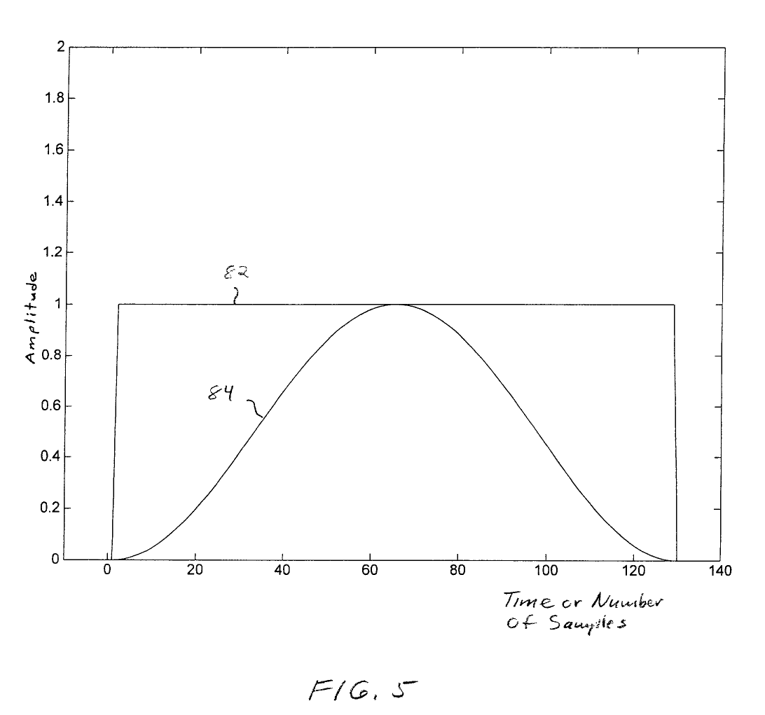

As shown in FIG. 3, increments of 128 samples in overlapped fashion are passed from stage 62 through buffer 80 to stage 64 wherein a windowed FFT is performed. The output of the FFT will represent the spectral information. In order to reduce interference between spectral information that are close to each other, the input data can be shaped or “windowed”. This is done by multiplying each input sample by a different scale factor. Typically the samples near the beginning and end are scaled close to zero and the samples near the middle are scaled close to one. This reduces the spectral spreading caused by the abrupt start and stopping of the data. In the illustrated implementation a Hanning Window was used to shape the input data. A Hanning Window defines a particular shape of scaling in signal processing. This is illustrated further in FIG. 5 wherein the non-weighted samples are represented by rectangle 82, the Hanning Window by curve 84 and the shaped or scaled samples are under the curve 84. Other types of windows which facilitate the analysis of the spectral information may be used.

The output of windowed FFT stage 64 which is 128 samples in length is transmitted through buffer 90 to single-sided power stage 66 where a scaled spectral power of the samples is computed by taking the square of the magnitude of the FFT output and scaling the same. In particular, since the input to the FFT is a real signal, the output of the FFT is symmetrical about the midpoint. Thus, only the first half of the FFT output need be used. Accordingly, the output of stage 66 contains half the number of input samples, e.g. the 64 samples present in output buffer 34.

The output of FFT power processing stage 30 is the computed power spectrum. Next, the results of stage 30 must be analyzed to determine the presence of speech.

The first analysis technique examined was to find the peak frequency within a certain range of frequencies and then determine the speech pitch. Once this was found, the first 5 harmonics of the peak frequency were measured in level and in frequency. In addition, the valleys between these peaks were measured in amplitude. If the peaks and valleys were within certain ranges and the frequencies were within certain ranges, the frame was decided as containing voice.

On the fixed-point processor, finding pitch turned out to be computationally intensive as well as extremely sensitive to quantization effects. It became evident that reduction methods were essential in order to speed up the analysis and reduce the sensitivity. The method is to perform an FFT and adjust a count of the number of bins above a threshold. The “pitch” method above does the same thing, except it is looking at specific frequencies. Therefore, if the lack of frequency validation does not cause the performance to suffer, then the algorithm time could be decreased. By removing this, the resulting algorithm compares all the peaks above a threshold and requires them to be within a certain count range. The threshold maps to a scaled average of the FFT output sample power. Testing showed that by doing this, no noticeable performance degradation was observed. The foregoing is illustrated further in FIG. 6 wherein the output sample power peaks are represented by the dots joined by dotted curve 92 and wherein the horizontal line 94 represents the scaled average of the FFT output sample power.

The operation of the frame validation component 40 of the system of FIG. 2 is illustrated further in FIG. 7. The output from stage 66 of the power processing component 30 is applied via buffer 100 to a compute spectral average stage 120. The spectral average is computed by summing the square of the magnitude of the first half of the output samples of the FFT. As previously described, since the input to the FFT is a real signal the output of the FFT from component 30 is symmetrical around the midpoint so that only the first half of the FFT output need be used. The sum is then divided by the number of samples used to compute the sum. In this case the first 64 output samples are squared and summed, and the sum divided by 64. This spectral average can then be modified by a scale factor. This result which is computed by stage 120 is represented by line 94 in FIG. 6.

The frame validation component 40 also includes an extract pitch range stage 126. In this stage a portion of the FFT power output is selected. In the illustrate implementation described herein, the portion selected consists of the 4th through the 32nd FFT output power samples. The outputs of stages 120 and 126 are applied to the inputs of a comparison stage 130 wherein the samples extracted for the pitch range are compared against the scaled spectral average. The number of FFT output power samples that are greater than the scaled spectral average are counted in stage 130. If the count is between a validation range, as examined by stage 134, a positive indication of speech detection is given for the frame being examined. In the illustrate implementation described herein 7 and 13 are used for the low and high limits of the validation range. The positive indication of speech detection is present in output buffer 46 for transmission to the flywheel routine component 50. However, in this embodiment of the invention it will be transmitted to component 50 only in response to either the presence of an enable command, or the absence of a disable command, on path 140 from the output of component 56 which will be described in detail presently.

Once frame validation component 40 determines whether or not a frame contains voice, that determination (positive or negative) is passed on to the flywheel routine 50. This routine, shown in further detail in FIG. 8, determines if voice is present, based on the individual frames which have been examined. Briefly, flywheel routine 50 counts the number of frames which have been determined to contain the signal component of interest, i.e. the voice signal, until a predetermined number of such frames is obtained indicating that the system is satisfied that the signal component of interest is present in the composite signal. Referring to FIG. 8, routine 50 includes a limited counter 150 which starts at zero. If voice is detected on a frame, the counter 150 is incremented by a certain value. In the example shown, when buffer 46 contains an indication that a frame contains voice, switch 152 is operated to increment counter 150 by the value of 20. Thus, counter 150 is incremented by 20 for each frame determined to contain voice. However, for each frame in which voice is not detected, switch 152 is operated to decrement counter 150 by the value of 7. During this mode of operation, switch 154 remains in the position shown wherein only the operation of switch 152 affects counter 150.

When a sufficient number of frames containing voice are detected to cause counter 150 to reach 100, the latch 160 is operated to provide an indication on buffer 162 that voice is detected. Meanwhile, switch 154 changes position to disconnect switch 152 from counter 150 and connect switch 164 thereto. Switch 164 in this example applies an increment value of 50 and a decrement value of 1 to counter 150. Thus, once speech is detected overall, it becomes difficult to become undetected. Thus, intersyllabic silence will not result in loss of the indication of speech in buffer 162. Each of the delay components 170 and 172 in routine 50 injects a one frame delay for proper operation of the routine.

As previously described, system 20 can include component 56 which detects the presence of a predetermined characteristic in the composite signal and which enables the operation of frame validation component 40 if that predetermined characteristic is present. For example, as indicated in connection with the arrangement of FIG. 1, when the signal component of interest is voice and when echo signals are present in the composite signal, component 56 performs a near end/far end power comparison. This, in turn, enables the system 20 to detect far-end speech in a situation like that of FIG. 1 while ignoring the echo by examining the near-end speech power.

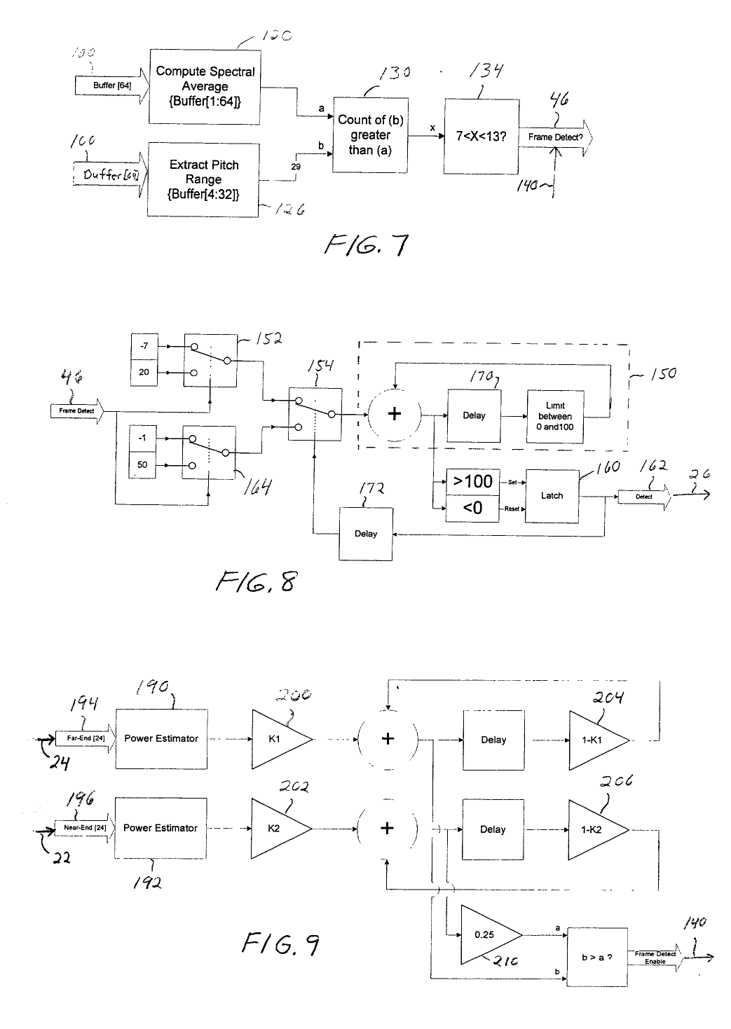

In particular, and referring to FIG. 9, in component 56 near-end power is compared to far-end power to enable the voice detection for the current frame. If the far end power is greater than a portion of the near end power then the voice detection is enabled for the current frame.

Power estimation is done in each of the stages 190 and 192 by computing a short term power estimate from a small number input samples then using that short term estimate to update a long term power estimate. To compute the short term power estimate a small number of input samples are squared then summed together. In the illustrative implementation of FIG. 9 that number is 24. Thus, far-end samples from path 24 in FIG. 1 are accumulated in buffer 194 and then input to far-end power estimator 190. Similarly, near-end samples from path 22 in FIG. 1 are accumulated in buffer 196 and then input to near-end power estimator 192.

The long term power estimation is initialized to zero and is updated by the short term power estimate as follows. When a new short term power estimate is available the new long term power estimate is computed by multiplying the new short term power estimate with a scale factor and multiplying the previous long term power estimate with a scale factor. The scaled short term power estimate is then added to the scaled previous long term power estimate.

In the arrangement of FIG. 9 the scale factors are shown by the triangles 200, 202, 204 and 206. The scale factors are chosen to adjust the rate of growth and decay of the long term power estimate. By way of example, in an illustrative implementation scale factors of K1=0.5 and K2=0.2 were used. Of course the gains of components 204 and 206 can be selected independently of components 200 and 202. If the long term power estimate of the far end voice is greater than some portion of the long term power estimate of near end then the voice detection is enabled. If not the voice detection is disabled. In the illustrative implementation of FIG. 9, the portion of the near end long term power estimate used is 25% i.e. the 0.25 factor shown in triangle 210.

While embodiments of the invention have been described in detail, that is for the purpose of illustration, not limitation.

1. A method of detecting a signal component in a composite signal comprising;
a) accumulating samples of the composite signal to provide a series of frames each containing a plurality of signal samples;
b) transforming each frame to provide transform products in the frames;
c) analyzing each frame to determine the number of transform products having an amplitude above a threshold; and
d) for each frame comparing that number to a validation range to determine if the frame contains the signal component.

2. The method according to claim 1, further including determining if the signal component is present in the composite signal based on the contents of a series of the individual frames.

3. The method according to claim 1, further including detecting the presence of a predetermined characteristic in the composite signal before the operation of determining the presence of the signal component can be performed.

4. The method according to claim 1, wherein transforming each frame is performed by a Fast Fourier Transform.

5. The method according to claim 1, including overlapping the frames in conjunction with transforming each frame.

6. The method according to claim 1, wherein transforming each frame is performed by a windowed transforming.

7. The method according to claim 1, wherein comparing the number of transform products includes determining if the number of transform products exceeds the computed spectral average of the transform products within the validation range.

8. The method according to claim 1, wherein determining if the signal component is present comprises counting the number of frames containing the signal component until a predetermined number of frames is obtained indicating that the signal component is present in the composite signal.

9. The method according to claim 1, wherein the signal component is voice in a composite signal containing voice and non-voice components.

10. The method according to claim 1, wherein the signal component is voice in a composite signal containing voice and network tone components.

11. The method according to claim 3, wherein the signal component is voice and the predetermined characteristic is utilized to determine the presence of echo in the composite signal.

12. A system for detecting a signal component in a composite signal comprising:
a) a processing component to accumulate a number of samples of the composite signal to provide a series of frames each containing a plurality of signal samples and to transform each frame to provide transform products in the frame; and
b) a frame validation component to analyze each frame to determine the number of transform products each having an amplitude above a threshold and to compare that number to a validation range to determine if the frame contains the signal component.

13. The system according to claim 12, further including a component to determine if the signal component is present in the composite signal based on the contents of the individual frames.

14. The system according to claim 12, wherein the processing component includes a component to overlap the frames in conjunction with the transform of each frame.

15. The system according to claim 12, wherein the processing component includes a component to window the transform of each frame.

16. The system according to claim 12, further including a component to detect the presence of a predetermined characteristic in the composite signal before operation of the frame validation component can be completed.

17. The system according to claim 12, wherein the signal component is voice in a composite signal containing voice and non-voice components.

18. The system according to claim 12, wherein the signal component in voice is a composite signal containing voice and network tone components.

19. The system according to claim 16, wherein the signal component is voice and the predetermined characteristic is utilized to determine the presence of echo in the composite signal.

20. A program storage device readable by a machine embodying a program of instructions executable by the machine to detect a signal component in a composite signal, the instructions comprising:
a) accumulating a number of samples of the composite signal to provide a series of frames each containing a plurality of signal samples;
b) transforming each frame to provide transform products in the frames;
c) analyzing each frame to determine the number of transform products having an amplitude above a threshold; and
d) for each frame comparing that number to a validation range to determine if the frame contains the signal component.
